(19) United States
(12) Patent Application Publication
(10) Pub. No.: US 2018/0089606 A1
(43) Pub. Date: Mar. 29, 2018

(54) SYSTEM AND METHOD FOR RANKING A BUSINESS

(71) Applicant: Waddell Creek Inc, San Francisco, CA (US)

(72) Inventor: Philip McNamara, San Francisco, CA (US)

(73) Assignee: Waddell Creek Inc, San Francisco, CA (US)

(21) Appl. No.: 15/717,386

(22) Filed: Sep. 27, 2017

Related U.S. Application Data
(60) Provisional application No. 62/400,840, filed on Sep. 28, 2016.

(51) Int. Cl. G06Q 10/06; G06Q 30/02

(52) U.S. Cl. CPC G06Q 10/06393; G06Q 50/01; G06Q 30/0201

(57) ABSTRACT

A system and method for ranking a business are provided. A rank score for a business is calculated based on verified information about the business provided by a person associated with the business itself, as well as publicly available information about the business gathered from trusted sources over a computer network. The information provided by the business may be verified according by direct contacts with clients, customers, or other entities that have had commercial interactions with the business, or documentary proof of past transactions with other commercial entities.

### CROSS REFERENCE TO RELATED APPLICATION

The present application claims the benefit of Provisional Patent Application Ser. No. 62/400840, filed on Sep. 28, 2016.

### BACKGROUND OF THE INVENTION

### A. Technical Field

The present invention relates to a system and method for ranking a business. The system and method calculate a rank score for a business based on verified information about the business provided by a person associated with the business itself, as well as publicly available information about the business gathered from trusted sources over a computer network. The information provided by the business is verified by direct contact with clients, customers, or other entities that have had commercial interactions with the business, or documentary proof of past transactions with other commercial entities.

### B. Description of Related Art

Businesses and consumers alike are relying more and more on online reputations. Businesses rely on positive reviews on websites like Yelp and Linkedin to drive traffic to their businesses. Consumers rely on customer reviews, both positive and negative, to determine which businesses they want to conduct business with. Thus, a positive online reputation can be a marketing boon for a business, while a negative online reputation can be a significant obstacle to the growth of a business.

While reputation sites can be helpful to both businesses and consumers, they also pose challenges. Reputation sites typically post reviews of businesses written by recent customers. First hand customer accounts of their experience can be a powerful driver of a company's online reputation and can have a strong influence on potential customers' decisions to transact business with a particular company or firm. Unfortunately, customer reviews are not always a fair or adequate method for evaluating the quality of a business. A single negative review can often have a disproportionate impact on potential customers, even in the face of many more complimentary reviews. Also, customer's who have had a negative experience are often more likely to post a review. Thus, online reviews are likely to skew more heavily toward the negative than they should. Finally, companies with dubious ethical standards can manipulate their online reputations by posting fake reviews—both false positive reviews for their own business and false negative reviews for their competitors—and through other untoward methods.

Another problem with typical online reputations sites is that it can be difficult for startup businesses, or simply businesses that are new to a particular reputation website, to establish an online reputation. Because such reputations are based primarily on customer reviews of past interactions, new businesses can be caught in a Catch-22: they can't get new customers until they have established a satisfactory online reputation, but they can't establish a satisfactory online reputation until they get new customers to post positive reviews.

The prior art includes attempts to address some of the difficulties associated with online reputation sites. US Patent Application Publication 2012/0310831 A1 to Harris, for example, describes a method of ranking a plurality of entities. The method disclosed by Harris calls for receiving information regarding a plurality of completed transactions from a plurality of users. A query is received from a first user regarding a proposed transaction. An algorithm determines at least one affinity between a first user and the plurality of users based on the received information. Harris then calls for determining a ranking, or expectation of success, for each of a plurality of potential entities for the proposed transaction based on the at least one affinity. A plurality of the selected entities are selected based on the ranking or expectation of success for each of the potential entities. Finally, Harris calls for sending the plurality of selected entities to the first user in response to the query.

US Patent Application Publication 2013/0317954 A1 to Psota discloses a platform that facilitates buyers, sellers, and third parties in obtaining information related to each other's transaction histories, such as a supplier's shipment history, the types of materials typically shipped, a supplier's customers, a supplier's expertise, what materials and how much a buyer purchases, buyer and shipper reliability, similarity between buyers, similarity between suppliers, and the like. The platform aggregates data from a variety of sources, including customs data associated with actual import/export transactions and facilitates the generation of reports as to the quality of buyers and suppliers, the reports relating to a variety of parameters that are associated with buyer and supplier quality.

Existing solutions collect information from multiple sites and/or other sources and provide aggregated information to a user, including sellers, buyers, consumer groups, entities, or individuals. The value of aggregated information depends on multiple factors, such as the authenticity of data, the attributes of the data and other factors. Inaccurate or false information within such aggregated information can destroy the meaning and usefulness of business rankings based on such aggregated information.

Accordingly, there exists a need for an improved system and method for ranking businesses based on the quality of their clients, and verifiable data such as genuine or original invoices, or other proof that a contract, or a past history of contracts, existing between business entities and their clients or customers.

### SUMMARY OF THE INVENTION

A system and method for calculating a rank score of a business is disclosed. The system and method calculate the rank score based on verified information about the business provided by a person associated with the business itself, as well as publicly available information about the business gathered from trusted sources over a computer network.

According to an embodiment of the invention a network system for providing verified business rankings includes a computer network, first and second client computers connected to the computer network and a server connected to the network adapted to communicate with the first and second client computers. The first client computer is associated with a business that is to be ranked by the system. The second client computer is associated with a user desiring to view a rank score associated with the business to be ranked. The server is adapted to execute a plurality of backend process modules.

The backend process modules include an intake process module. The intake module is adapted to request and receive company profile data from the first client computer over the computer network. The company profile data includes the name of one or more clients/customers of the company. The company profile data further includes contact information for a contact within each of the clients/customers or transaction data associated with one or more transactions between the company and the clients/customers of the company.

The backend process modules further include a verification module adapted to verify that the one or more clients/customers named in the company profile data are true clients/customers of the company. The verification module further verifies the accuracy of the transaction data provided in the company profile data associated with the transactions between the company and the one or more clients/customers of the company.

Next, the backend process modules include a ranking module. The ranking module is adapted to calculate a rank score for the company based on the one or more verified clients/customers of the company identified in the company profile data and the verified transaction data associated with the one or more transactions between the company and the one or more clients/customers of the company. The ranking module further takes into account publicly available information about the company gathered from trusted sources over the computer network. Finally, the backend process modules include an output module adapted to receive a request from the second client computer for the rank score for the company. Upon receiving such a request, the output module communicates the rank score for the company to the second client computer via the server over the computer network.

A method according to an embodiment of the invention generates a verified rank score representing an assessment of a business' reputation and communicating the rank score to an individual considering doing business with the business entity. The method includes the step of receiving information about a business entity at a network server. The information is received from a source associated with the business entity over a computer network. The information about the business entity includes the name of at least one client/customer of the business and the amount of business transacted between the client/customer and business entity. The information about the business may also include an email address of a contact person associated with the client/customer who may verify that the client/customer has in fact transacted business with the business entity and the amount of the business transacted. Alternatively, or in addition, the information about the business may include electronic copies of transaction documents proving the amount of business transacted between the client/customer and the business entity. The inventive method then calls for creating a profile of the business entity, wherein the profile includes the information about the business entity received from a source associated with the business entity over the computer network. The profile data is then stored in a data storage unit associated with the server. The method then calls for verifying the relationship between the business entity and the client/customer and the amount of business transacted therebetween. In addition to the information received from a source associated with the business entity, the method further calls for obtaining publicly available information about the business entity from a remote database over the computer network. Finally, the inventive method calls for calculating the rank score based on the verified client/customer of the business entity, the amount of business transacted between the verified client/customer and the business entity as well as the publicly available information about the company.

Still another embodiment of the invention provides a method of verifying that an organization is a client/customer of a company. The method according to this embodiment includes the step of receiving profile data about the company over a computer network. The profile data is stored as a profile record for the company in a database. The profile record includes, among other things, a contact name and an email address for a contact person associated with the organization capable of verifying that the organization is a client/customer of the company. Next the method calls for retrieving the contact name and email address for the contact person associated with the organization from the database and generating a pre-scripted email message addressed to the contact person associated with the organization. The pre-scripted email message includes a request that the contact person verify that the organization is a client/customer of the company. The pre-scripted email is then sent to the email address for the contact person associated with the organization over the computer network. The organization is verified as client/customer of the company when an affirmative response to the email is received.

### BRIEF DESCRIPTION OF THE DRAWINGS

FIG. 1 is a schematic over of a network system for ranking a business according to an embodiment of the invention.

FIG. 2 is a screen shot of a customer verification interface page;

FIG. 3 is a screen shot of an upload proofs interface page;

FIG. 4 is a flowchart illustrating the steps performed in ranking a business according to an embodiment of the invention.

### DETAILED DESCRIPTION OF THE PREFERRED EMBODIMENT

The present invention relates to a system and method for generating and presenting verified rankings for one or more business entities. For purposes of the present disclosure, a business entity may be a publicly traded corporation, a closely held company, a sole proprietorship, a professional corporation or partnership, an individual, or any other entity or organization engaging in commercial activity. For convenience, any such business henceforth will be referred to as a “company” though the business may take any of the above-mentioned forms. The system relies on both verified private information supplied by the company being ranked, as well as publicly available information about the company from trusted sources.

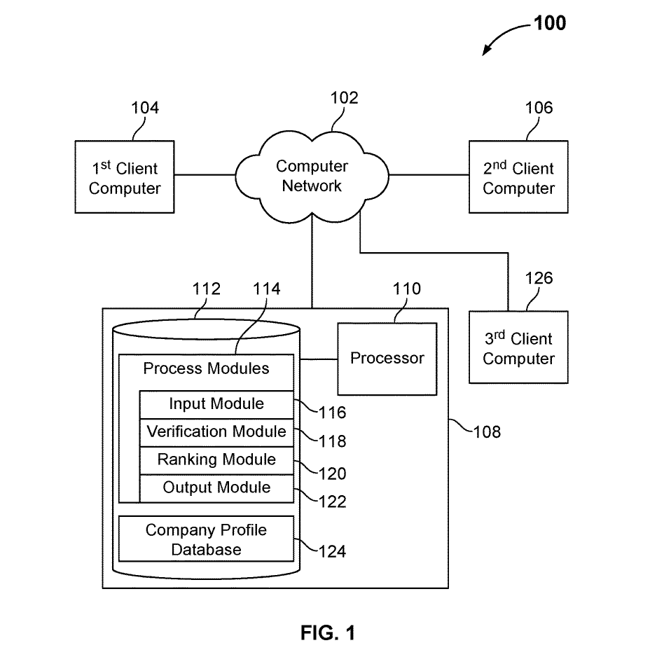

Turning to FIG. 1, a system 100 for generating and presenting verified business rankings includes: a computer network 102; a first client computer connected to the computer network 102, the first client computer being associated with a company desiring to be ranked; a second client computer 106 connected to the computer network associated with a client or customer of the company desiring to be ranked; a third client computer 126 connected to the computer network 102 associated with a third party desiring to view company rankings; and a network server 108. The server 108 includes a processor 110 and a data storage unit 112. The data storage unit 112 stores, among other things, program instructions which may be executed by the processor 110 to implement a number of process modules for implementing the method for generating and presenting verified business rankings according to the present invention. The process modules stored in the data storage unit 112 include: an input module 116; a verification module 118; a ranking module 120 and an output module 122. The data storage unit also stores a database of company profile data for the companies ranked by the system 100. It should be noted that the data storage unit 112 is a logical construct only and may actually comprise one or many physical data storage components. First, second and third client computers 104, 106, 126 may comprise a mainframe, desktop or laptop computer, a tablet computer, a smartphone or any other device capable of communicating over the computer network 102 and displaying information for a user.

The input module 116 acts as a web portal whereby a user associated with a company desiring to be ranked may interact with the server 108 to create a company profile and initiate the verification and ranking processes. The input module 116 accomplishes this by generating one or more profile interface pages. The server sends the profile interface pages to the first client computer 104 over the computer network 102 where they are displayed for the user. The profile interface pages include a plurality of fields into which the user may enter information about the company. For example, a first profile interface page may include fields for entering basic information about the company, including: the name of the company; the year the company was founded; a URL pointing to the company's website; a description or summary of the company's activities; a list of reasons a potential client ought to hire the company over its competitors; whether the company is open for business; and the like.

Another profile interface page may include additional fields for entering more detailed information about the company. These details may include, for example, the company's tax identification number (TIN) or DUNS number; the company's corporate address; a list of individuals authorized to edit the company's profile; the primary administrator of the company's profile; the email address or addresses of one or more key sales contacts for the company; and a phone number of the the company's primary contact.

Yet another profile interface page may provide fields into which the user may enter links to various electronic files such as an image of the corporate logo or a background image to be displayed along with the company's profile when a potential customer views the company's profile and business rank score. Links may also be entered for uploading the organizations brochure, or a youtube video advertising the company, or the like. Still other fields may allow a user to enter information relating to the company's internet or social media presence. For example, interface fields may be provided for entering the URL for the company's web page; the company's Facebook, LinkedIn or Github usernames or twitter handle.

Another profile interface page may allow the user to enter information about the company's clients or customers. When adding new clients or customers to the company's profile additional interface pages my also be displayed related to verifying information regarding the scope and duration of company's relationship to the client or customer being added. (The subject of verifying customer relationships will be addressed in more detail below with regard to the operation of the verification module.)

Still another profile interface page may be provided in which the user may enter information relating to important projects the company has been involved with in the past. Such an interface page may include, for example, a field in which the user may upload a case study describing a project, or discrete fields into which the user may enter the title of a project; the client or customer who hired the company for the project; the skills required for the project; the start and completion dates for the project; or a description the company's role in the project.

A certifications/accreditations profile interface page may be provided to allow the user to enter significant certifications or accreditations the company or company personnel have obtained or acquired that may give the company an advantage over its competitors. Such an interface page may include fields for the name of the certification or accreditation, the authority granting the certification or accreditation, the date on which the certification or accreditation was awarded, and the like. Such a profile interface page further include details for verifying the certification or accreditation. Such as an email address for the authority granting the certification or accreditation or a URL link to the authority where the certification or accreditation may be verified.

Finally, additional profile interface pages may elicit information regarding the products or services offered by the company; the percentage of the company's business devoted to particular products, services or industries; critical expertise possessed by the company or specialties practiced by the company or the company's personnel, and the like. Interface pages may further gather information regarding the company's locations and the number of employees or other resources located at various locations.

The data entered by the user into the interface pages generated by the input module 116 are transmitted via the network 102 back to the server 108. The input module 116 then stores the profile data as a profile record for the company in the user profile database 124 within the data storage unit 112.

Once the user profile has been created and the user profile data are stored in the company profile database 124, the verification module 118 acts on the data to verify whether various assertions made about the company in the profile are true. For example, the verification module 118 takes steps to verify whether each customer or client identified as a customer or client of the company is in truth an actual client or customer of the company. The verification module employs one of two methods for verifying customer/client relationships with the company, depending on the profile information entered by the user who created the company's profile. The first is via direct communication with a contact person associated with an individual or organization identified as a client or customer of the company. The second is by analyzing documentary proofs of the client or customer relationship between the purported client or customer and the company.

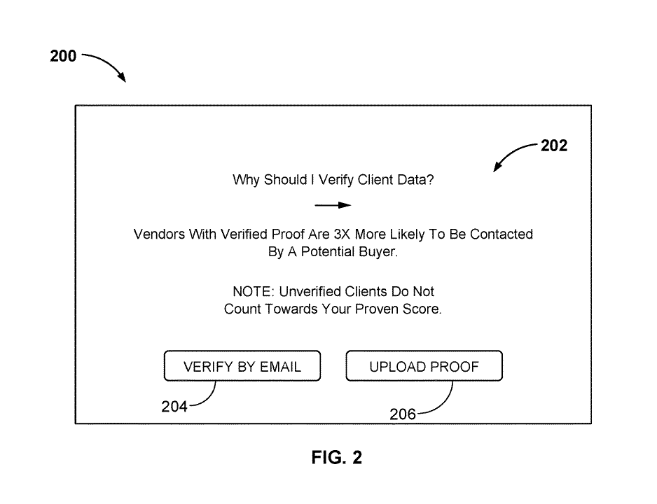

As has been described above, one of the steps in creating a company profile is to create a list of the company's clients and customers. When a client/customer is added to the company's list of customers and clients, the input module provides a customer verification interface page 200 shown in FIG. 2. The customer verification interface page 200 includes a statement 202 informing the user why it is advantageous to verify clients/customers. The customer verification interface page 200 further includes two options for verifying that the identified client or customer is in fact a client or customer of the company.

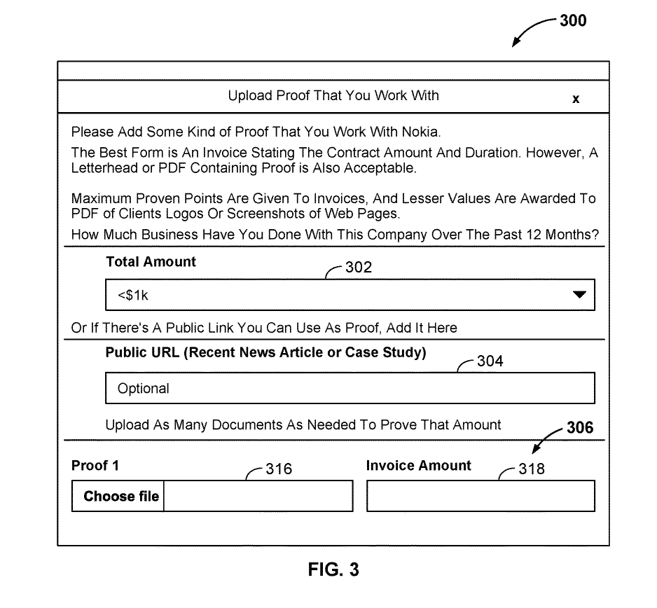

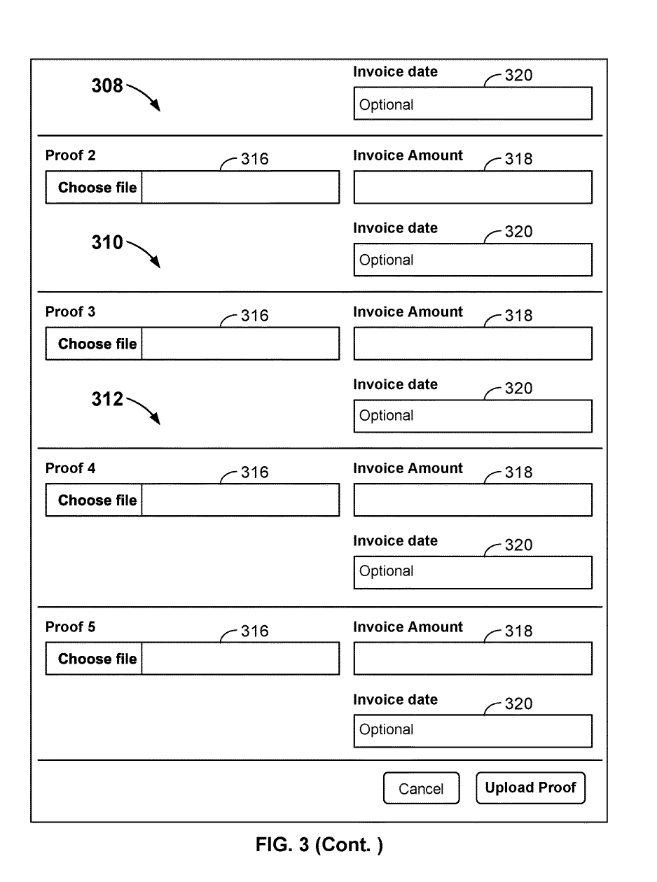

The first option is accessed by a first user selectable interface button 204 labelled “Verify By Email.” The second verification option is accessed by a second user selectable interface button 206 labelled “Upload Proofs. Selecting the Verify By Email button 206 initiates an email verification process in which a subsequent email verification interface page shown in FIG. 3 is displayed for the user. The email verification interface page 200 includes an input field 302 for receiving the name of a contact person associated with the client/customer who may verify the client's/customer's relationship with the company. The interface page 300 further includes an input field 304 for receiving an email address for the contact person. The verification module generates and sends, via the computer network 102, a pre-scripted email message to the contact person whose email address was provided by the user via the computer network 102. The pre-scripted email message explains to the contact person that the user at the company is seeking verification of the as yet unverified client/customer relationship between the identified client/customer and the company. The contact person receives and may view the email message on the second client computer 106. The contact person may affirm the identified client's/customer's relationship with the company by responding positively to the email. The contact person's response is returned to the server 108 via the computer network 102. Upon receiving a positive response to the email the verification module recognizes the identified client/customer relationship as a verified client/customer of the company. As will be described in more detail below, once the client/customer relationship has been verified, the relationship may be factored into the rank score for the company calculated by the ranking module 120.

If, on the other hand, the user selects the Upload Proofs interface button 206 on the customer verification interface page 200, the verification module initiates an alternative client/customer verification process. In this case the verification module generates a proofs interface page 300 shown in FIG. 3. The server sends the proofs interface page 300 to the first client computer 104 where it is displayed for the user. The proofs interface page 300 includes a plurality of input fields into which the user may attach files that prove the client/customer relationship between the company and the identified client/customer. A first input field 302 is adapted to receive a dollar amount reflecting the amount of business conducted between the company and the identified client/customer. A second input field 604 is adapted to receive a public URL pointing to a news article, case study or some other publicly available document that describes the relationship between the company and the identified client/customer, and the amount of business conducted between them. Entering a URL in this field is optional.

Following the URL (recent news article or case study) field 304, the proofs interface page 300 presents a plurality of proof document input sections 306, 308, 310, 312, 314. Each proof document input section includes a proof document input field 316, and invoice amount field 318, and an invoice date field 320. The user may select a file stored on the first client computer 104 or enter the pathname for a document stored on the first client computer104 that verifies a transaction between the company and the identified client/customer into the proof document input field 316, for each document the user wishes to rely on for verifying the relationship between the company and the identified client/customer. The user may also enter an invoice amount in the invoice amount field 318, and an invoice date in the invoice date field 320 corresponding to each document the user enters in the proof document fields 316 of the various proof document input sections 302, 308, 310, 312. The user may attach as many proof documents necessary to justify the total amount value entered in the first input field 302 at the top of the proofs interface page 300. Upon completion of the requisite proof document input sections, the user may upload the proof documents to the server 108 via the computer network 102 by selecting the upload proofs selectable interface button 322 located at the bottom of the proofs interface page 300. Upon receiving the proof documents, the server 108 stores the received documents and the accompanying data in the data storage unit 112 as part of the company's profile record. The verification module 118 analyzes of the authenticity of the proof documents and verifies the total amount of business transacted between the company and the identified client/customer. Once the authenticity of the proof documents and the total amount of business transacted between the company and the identified client have been verified, the verification module 118 recognized the identified client/customer as a verified client/customer. Again, once the client/customer relationship has been verified, the relationship may be factored into the rank score for the company calculated by the ranking module 120.

The ranking module 120 calculates a rank score for the company based on verified information about the company. The verified information from which the rank score is calculated includes the user supplied information verified by the verification module 112, as well as information about the company gathered from trusted public sources.

The rank score output from the ranking module 120 comprises a number from 0-100 that is intended to convey the relative strength of the company based on a number of criteria. The Rank score R_{Total} is calculated as the sum of a plurality of weighted components. Each component is a measure of the company's strength according to a different set of criteria. For example, if the company is publicly traded, the first component of the rank score may be a measure of the company's position in the market based on its market capitalization and its annual revenue. Another component may be a measure of the company's position within the particularly industry in which it operates. Another component may comprise a measure of the company's social media presence. Yet another component may provide an indication of the strength of the company's customer or clients or customers (this based on the assumption that a firm having solid high performing clients or customers must itself be a strong firm). Still another component may comprise a measure of positive or negative feedback about the company provided by its clients or customers. Each component score is multiplied by a weighting factor according to the relative importance to be given to each component in the overall rank score.

Using the components described above, the rank score R_{Total} may expressed as follows:

R_{Total}=W_{M}Rₘ+W_{I}R_{I}+W_{S}R_{S}+W_{C}R_{C}W_{F}R_{F}

### Where:

R_{M}=the market component of the Total Rank Score;

R_{I}=the industry component of the Total Rank Score;

R_{S}=the social media component of the Total Rank Score;

R_{C}=the client component of the Total Rank Score; and

R_{F}=the feedback component of the Total Rank Score.

### And:

W_{M}=the weighting factor of the market component of the rank score;

W_{I}=the weighting factor for the industry component of the rank score;

W_{S}=the weighting factor for the social media component of the rank score;

W_{C}=the weighting factor for the client component of the rank score; and

W_{F}=the weighting factor for the feedback component of the rank score.

Since each component R_{M}, R_{I}, R_{S}, R_{C}, R_{F} is but a fraction of the total Rank Score, the weighting factors may be bounded by the equation:

W_{M}+W_{I}+W_{S}+W_{C}+W_{F}=1.

Like the total rank score R, the component scores may be expressed as numbers ranging from 0-100, with 0 being the lowest or worst score and 100 being the highest or best score for each component.

According to an embodiment of the invention the component values of the rank score R_{Total} may be calculated as follows:

### Market Relevance

R_{M} is defined by the formula:

$${R}_{M} = 100 \cdot tanh ( {α}_{M} \frac{market capitalization}{annual revenue} )$$

Where α_{M} is a tuning constant provided to give significance to the market capitalization/annual revenue ratio. In other words, the tuning constant α_{M} scales the capitalization/annual revenue ratio in a manner that defines which values may be considered “good” and thus result in a high score (near 100) and those values which should be considered “bad” and thus result in a lower score (near 0). The hyperbolic tangent function is used to bound the RM value. The tanh function is substantially linear for small values of the argument

$$( {α}_{M} \frac{market capitalization}{annual revenue} )$$

and has a fixed asymptote of 1. Employing this formula, a company having a relatively large market capitalization/annual revenue ratio will have a high R_{M} value near 100, whereas a company with a relatively small capitalization/annual revenue ratio will have a low R_{M} near 0. A company with no market capitalization or a company whose market capitalization and/or annual revenue are unknown will result in a market component value R_{M}=0.

Industry Relevance

R_{I} is defined by the formula:

$${R}_{I} = 100 \cdot tanh ( {α}_{I} \frac{{\sum }_{i} {V}_{i} / {L}_{i}}{{V}_{Mean}} )$$

Again, α_{I} is a constant provided to give significance to the value

$$\frac{{\sum }_{i} {V}_{i} / {L}_{i}}{{V}_{Mean}} . {V}_{i}$$

is the value of a contract the company has with its i^{th} client, and Lᵢ is the length of that contract in years. V_{Mean} is the mean average value of a contract in the particular industry in which the company operates. Thus, the R_{I} component correlates the company's contract portfolio to the average contract portfolio in the industry.

Social Media Presence

R_{S} is defined by the formula:

$${R}_{S} = 10 \cdot {w}_{Google} \cdot {r}_{Google} + 100 \cdot {w}_{Alexa} \cdot tanh ( \frac{{α}_{Alexa}}{{r}_{Alexa}} ) + 100 \cdot {w}_{Twitter} \cdot tanh ( \frac{number of twitter folowers}{{α}_{Twitter}} )$$

Where W_{Google}, W_{Alexa}, and W_{Twitter} are arbitrary weighting factors that designate the relative importance given to each social media platform's particular ratings metric. As with the R_{S} weighting factors, W_{Google}, W_{Alexa}, and W_{Twitter} are bounded by the relationship:

W_{Google}+W_{Alexa}+W_{Twitter}=1.

r_{Google} is a value from 1-10 corresponding to Google's ranking of the company based on Google's own ranking criteria. r_{Alexa} represents the company's Alexa rank based on Amazon's ranking criteria. α_{Alexa} and α_{Twitter} are tuning parameters which adjust the significant of the arguments in the tanh function according to the social media presence of different categories of companies.

Client Quality

R_{C} is defined by the formula:

$${R}_{c} = 100 \cdot tanh ( \frac{number of contracts}{{β}_{c}} )$$

Where β_{C} is a tuning parameter that may be adjusted for different categories of companies, or companies in different industries. For example, a small business may be expected to have many fewer contracts than a large multinational corporation. Similarly, a company in an industry where each contract is a large multi-year commitment, such as a contract to build a bridge or a dam would be expected to have far fewer contracts than a company whose business is based on large volumes of small contracts such for example a cable tv provider or a mobile phone service provider.

Customer/Client Feedback

R_{F} is defined by the formula:

$${R}_{F} = 10 \cdot \frac{{\sum }_{i} {score}_{i}}{number of scores}$$

Where scoreᵢ is the feedback score, a value from 0-10, given by the company's i^{th} client/customer to provide a feedback score. In other words, R_{F} is simply the average feedback score of all the customers/client who provided feedback scores for the company multiplied by 10.

Once the input module 116 has gathered and stored all of the company's relevant information, and the verification module 118 has verified all of the company's relevant data capable of being verified, and the ranking module 120 has calculated the rank score, the output module 122 assembles the company's information, including the rank score R_{Total} into one or more reports. The one or more reports may include the Ranks Score for the company, as well as an analysis of the components that when into developing the company's rank score. The reports may comprise interface pages that may be sent to the first client computer 104 where it may be displayed for the user. At the user's discretion, various reports may be made public, so that a verified third party user, who may be interested in doing business with the company may view the reports on the third client computer 126. Using the third client computer 126 the third party user may request profile information for the company including the company's rank score. The output module 122 generates various interface pages including the reports and transmits requested interface pages to the third client computer 126 over the computer network 102 where they may be reviewed by the third party user.

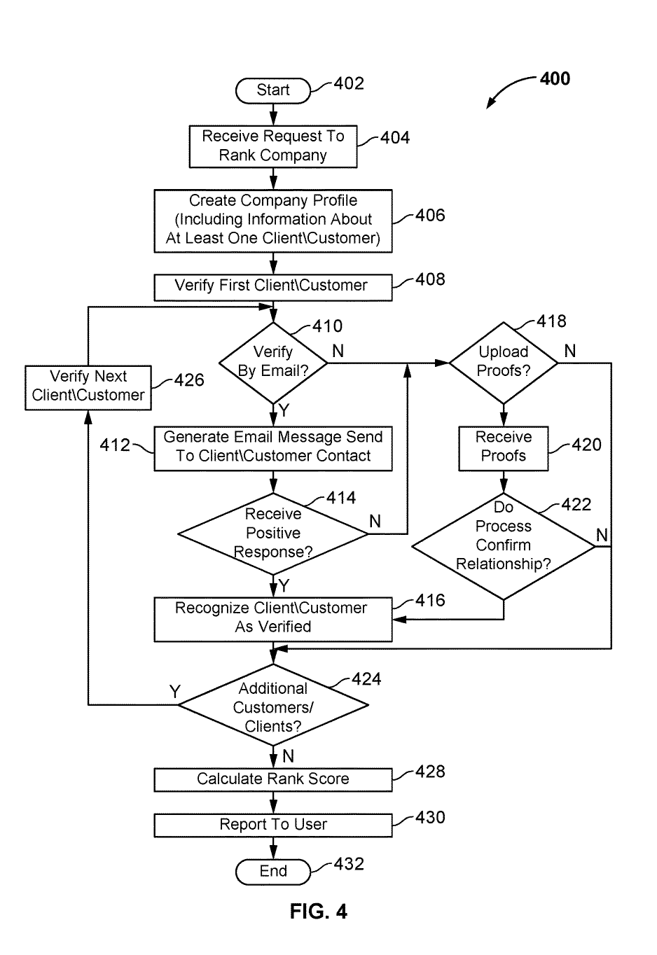

FIG. 4 is a flow chart 400 representing the process of ranking a company according to an embodiment of the invention. The process begins 402. A request to rank a company is received at step 404. The first step in ranking the company is the creation of a company profile at step 406. As has already been described, the company profile includes detailed information about the company—the size of the company; where it is located; financial data such as annual revenue and profits; the industries it serves; and so forth. Included in the company profile is the name of at least one significant client or customer of the company.

Once the company profile has been created, the next step is to verify the first client or customer named in the profile, beginning at step 408. The user decides whether or not to verify the client via email message at decision block 410. If the user decides not to verify the identified client/customer via email at decision block 410, the process proceeds to decision block 418. Decision block 418 initiates a separate verification process that involves the user submitting documentary proof of the company's relationship with the identified client/customer. The documentary proof verification process will be discussed further below. Returning to decision block 410, however, if the decision is made to verify the client/customer via email, the process proceeds to step 412 where the system generates an email that is sent to a contact person associated with the client/customer organization asking the contact person to confirm the identified client's/customer's relationship with the company. The contact person to whom the email is addressed as well as the contact person's email address are included in the information gathered when the company's profile is created. Though not included in the flow chart 400, the email address for the contact person may itself be verified. This is accomplished by confirming that the domain name within the contact's email address matches a known internet domain name of organization being represented as a client or customer of the company. If not, the contact person is not considered independent and my not be relied upon to verify the identified client's/customer's relationship with the company. If the contact person's email address checks out, the email is sent to the contact person at the designated email address. The email explains to the contact person that the company is in the process of being ranked, and that as part of the ranking process the company is asking the contact to verify that the organization the contact is associated with is in fact a client or customer of the company.

The verification process continues to decision block 414 where the process determines whether or not a positive response to the email has been received. If yes, the identified client/customer is recognized as a verified client/customer at step 416. If a positive response to the email is not received, the process moves on to the alternative, documentary proof verification process.

If the user elects not to verify the client/customer via email at 410, or if the email sent to a contact at the identified client/customer organization fails to garner a positive response, the user is provided an opportunity to verify the client/customer by uploading documentary proof of the relationship at 418. If the user chooses not to verify the client/customer via documentary proof, the process proceeds to decision block 424 where the process determines whether there are additional clients/customers to verify. If, however, the user chooses to verify the client/customer via documentary proofs, the user uploads documents (purchase orders, invoices, receipts, etc.) that prove the relationship at step 420. The process then determines at decision block 422 whether the proofs provided at step 420 adequately verify the identified client's/customer's relationship with the company. If not, the process proceeds to decision block 424 where the process determines whether there are additional clients/customers to verify. If, however, the process does in fact determine that the proofs provided do in fact support a finding that the identified client/customer is a legitimate customer of the company, the identified client/customer is recognized as verified at step 416.

Once the identified client/customer has been recognized as a verified client/customer at step 416, or if the user chooses not to upload documentary proofs at decision block 418, or if the user provided documentary proofs do not support recognizing the identified client/customer as a verified client customer at decision block 422, the process determines at decision block 424 whether or not additional clients/customers named in the company's profile require verification. If so, the process proceeds to verify the next client at step 426, and the verification process is repeated as described. If, however, it is determined at decision block 424 that there are no more customer/clients that require verification, the process calculates a ranks score for the company at step 428. Once the rank score is calculated it is reported to the user user at step 430 and the process ends at 432.

Various embodiments of the invention have been described and illustrated; however, the description and illustrations are by way of example only. Other embodiments and implementations are possible within the scope of the invention and will be apparent to those of ordinary skill in the art. Therefore, the invention is not limited to the specific details of the representative embodiments and illustrated examples in this description. Accordingly, the invention is not to be restricted except as necessitated by the accompanying claims and their equivalents.

What is claimed is:

1. A network system for providing verified business rankings, the system comprising:
a computer network;
a first client computer connected to the computer network, the first client computer associated with a business to be ranked;
a second client computer connected to the computer network, the second client computer associated with a user desiring to view a rank score associated with the business;
a server connected to the computer network adapted to communicate with said first and second client computers, the server executing a plurality of backend process modules including:
an intake process module adapted to request and receive company profile data from the first client computer over the computer network, the company profile data including the name of one or more clients/customers of the company and at least one of contact information for a contact within each of the at least one client/customer of the company and transaction data associated with one or more transactions between the company and the at least one client/customer of the company;
a verification module adapted to verify that the one or more clients/customers named in the company profile data are true clients/customers of the company and the accuracy of the transaction data associated with the one or more transactions between the company and the one or more clients/customers of the company;
a ranking module adapted to calculate a rank score for the company based on the one or more clients/customers of the company identified in the company profile data and the transaction data associated with the one or more transactions between the company and the one or more clients/customers of the company verified by the verification module; and
an output module adapted to receive a request from the second client computer for the rank score for the company and to communicate the rank score for the company to the second client computer over the computer network.

2. The network system for providing verified business rankings of claim 1 wherein the verification module is adapted to analyze the contact information of the contact within the one or more clients/customers of the company to ensure that the contact is independent of the company, and to generate and transmit a verification request message to the contact requesting the contact verify that the client/customer is a true client/customer of the company over the computer network.

3. The network system for providing verified business rankings of claim 2 wherein the contact information includes an email address of the contact and the verification message comprises an email message addressed and sent to the contact at the email address, the email message requesting that the contact verify that the client/customer is a true customer of the company.

4. The network system of claim 3 wherein the verification module is adapted to verify the client/customer as a true client/customer of the company upon receiving a positive response to the email from the contact.

5. The network system for providing verified business rankings of claim 3 wherein the email message asks the contact to verify the transaction data associated with the one or more transactions between the client/customer and the company.

6. The network system for providing verified business rankings of claim 1 wherein the verification module is adapted to receive transaction verification documents from the first client computer over the computer network, the transaction verification documents comprising at least one of purchase orders, invoices, and receipts, the transaction verification documents including details of the transactions between the company and the client/customer.

7. The network system for providing verified business rankings of claim 6 wherein details of the transactions comprise at least one of a transaction amount and a contract duration.

8. The network system for providing verified business rankings of claim 1 wherein the ranking module calculates the rank score based at least in part on one or more of a market relevance component; an industry relevance component; a client quality component; a social medial presence component; and a client feedback component.

9. The network system for providing verified business rankings of claim 1 wherein the ranking module calculates the rank score for the company according to the formula:
R_{Total}=W_{M}Rₘ+W_{I}R_{I}+W_{S}R_{S}+W_{C}R_{C}+W_{F}R_{F}
where:
R_{M}=the market component of the Total Rank Score;
R_{I}=the industry component of the Total Rank Score;
R_{S}=the social media component of the Total Rank Score;
R_{C}=the client component of the Total Rank Score;
R_{F}=the feedback component of the Total Rank Score;
and:
W_{M}=the weighting factor of the market component of the rank score;
W_{I}=the weighting factor for the industry component of the rank score;
W_{S}=the weighting factor for the social media component of the rank score;
W_{C}=the weighting factor for the client component of the rank score;
W_{F}=the weighting factor for the feedback component of the rank score.

10. The network system for providing verified business rankings of claim 9 wherein the market relevance component is calculated according to the formula:
$${R}_{M} = 100 \cdot tanh ( {α}_{M} \frac{market capitalization}{annual revenue} ) .$$

11. The network system for providing verified business rankings of claim 9 wherein the industry relevance component is calculated according to the formula:
$${R}_{I} = 100 \cdot tanh ( {α}_{I} \frac{{\sum }_{i} {V}_{i} / {L}_{i}}{{V}_{Mean}} ) .$$

12. The network system for providing verified business rankings of claim 9 wherein the client quality component is calculated according to the formula:
$${R}_{c} = 100 \cdot tanh ( \frac{number of contracts}{{β}_{c}} ) .$$

13. The network system for providing verified business rankings of claim 9 wherein the social media presence component is calculated according to the formula:
$${R}_{S} = 10 \cdot {w}_{Google} \cdot {r}_{Google} + 100 \cdot {w}_{Alexa} \cdot tanh ( \frac{{α}_{Alexa}}{{r}_{Alexa}} ) + 100 \cdot {w}_{Twitter} \cdot tanh ( \frac{number of twitter folowers}{{α}_{Twitter}} )$$
where:
W_{Google}+W_{Alexa}+W_{Twitter}=1.

14. The network system for providing verified business rankings of claim 9 wherein the client feedback component is calculated according to the formula:
$${R}_{F} = 10 \cdot \frac{{\sum }_{i} {score}_{i}}{number of scores} .$$

15. A method for generating a verified rank score for a business entity, the rank score representing an assessment of the business' reputation, and communicating the rank score to an individual considering doing business with the business entity, the method comprising the steps of:
receiving at a network server information about the business entity from a source associated with the business entity over a computer network, the information about the business entity including a name of at least one client/customer of the business, an amount of business transacted with the client/customer and at least one of: an email address of a contact person associated with the client/customer who may verify that the client/customer has transacted business with the business entity and the amount of the business transacted; and electronic copies of transaction documents proving the amount of business transacted between the client/customer and the business entity;
creating a profile of the business entity, the profile including the information about the business entity received from a source associated with the business entity over the computer network;
storing the profile in a data storage unit associated with the server;
verifying the relationship between the business entity and the client/customer and the amount of business transacted therebetween;
obtaining publicly available information about the business entity from a remote database over the computer network; and
calculating the rank score based on the verified client/customer of the business entity, the amount of business transacted between the verified client/customer and the business entity and the publicly available information about the company.

16. The method for generating a verified rank score for a business entity of claim 15 wherein the information about the business entity includes the name and email address of the contact person associated with the client/customer of the business entity, and wherein the step of verifying the relationship between the business entity and the client/customer and the business transacted therebetween comprises sending an email from the network server to the email address of the contact person associated with the client/customer requesting that the contact person verify that the client/customer has transacted business with the business entity, and the amount of the business transacted.

17. The method for generating a verified rank score for a business entity of claim 15 wherein the information about the business entity includes an electronic copy of at least one of a purchase order; an invoice; a receipt; a published article; and a case study, verifying that the client/customer has transacted business with the business entity, and the amount of the business transacted.

18. The method for generating a verified rank score for a business entity of claim 15 wherein the step of calculating a rank score comprises summing a plurality of weighted components.

19. The method for generating a verified rank score for a business entity of claim 18 wherein the plurality of weighted components comprise at least one of a market strength score; an industry strength score; a social media presence score; a client/customer strength score; and a client/customer feedback score.

20. A method of verifying that an organization is a client/customer of a company comprising the steps of:
receiving profile data about the company over a computer network;
storing the profile data in a profile record for the company in a database, the profile record including a contact name and an email address for a contact person associated with the organization capable of verifying that the organization is a client/customer of the company;
retrieving the contact name and email address for the contact person associated with the organization from the database;
generating a pre-scripted email message addressed to the contact person associated with the organization requesting that the contact person verify that the organization is a client/customer of the company;
sending the email to the email address for the contact person associated with the organization over the computer network; and
verifying that the organization is a client/customer of the company upon receipt of an affirmative response to the email.
